(19) United States
(12) Patent Application Publication
(10) Pub. No.: US 2004/0177870 A1
(43) Pub. Date: Sep. 16, 2004

(54) Curb and sidewalk cleaner

(76) Inventor: Donald W. Wilson, Sarasota, FL (US)

Correspondence Address: Patricia E. McQueeney, Esq., Becker & Poliakoff, P.A., 3111 Stirling Road, Fort Lauderdale, FL, 33312, US

(21) Appl. No.: 10/385,048

(22) Filed: Mar. 10, 2003

(51) Int. Cl. B08B 3/02

(52) U.S. Cl. 134/172; 134/198; 134/199

(57) ABSTRACT

The present invention provides a novel, curb-conforming, multi-nozzle spray nozzle apparatus and a mobile pressure washing unit to permit curb cleaning without requiring human intervention. In addition, the novel, curb-conforming, multi-nozzle spray nozzle apparatus of the present invention is configured to address a variety of curb shapes, rather than the simple straight configurations of the prior art. The combination of these two items permit a significant reduction in the time and energy required to clean the curbs and sidewalks of a large neighborhood.

### BACKGROUND OF THE INVENTION

The modern age's obsession with cleanliness has now expanded to include the outdoors. Several areas of the country have homeowners' covenants that require the sidewalks to remain clean. In Florida, for example, there are many business ventures directed to providing lawn care and maintenance, including edging the lawn and pressure spraying the sidewalks. There are many inventions directed to the use of pressure sprayers to eliminate weeds and clean surfaces. See, e.g., U.S. Pat. No. 4,290,442 to Shaffer; U.S. Pat. No. 5,180,108 to Miyamoto; and U.S. Pat. No. 5,297,730 to Thompson. Many of these inventions focus on recycling the water or containing hazardous waste that may be present on the sidewalks' surface. See, e.g., U.S. Pat. No. 5,469,597 to Page; U.S. Pat. No. 5,826,298 to Rohrbacher et al; and U.S. Pat. No. 5,991,968 to Moll et al. The present invention improves upon the prior art by providing a mobile unit containing sufficient quantities of water to clean the surface and sides of many miles of sidewalks and curbs without requiring a person to walk all those miles.

Multi-nozzle spray systems are also known in the prior art. See, e.g., U.S. Pat. No. 4,022,382 to Engdahl, Jr.; U.S. Pat. No. 4,095,746 to Anderberg et al.; and U.S. Pat. No. 5,297,730 to Thompson. All of these inventions utilize straight, or linear, multi-nozzle spray nozzle apparati. The only prior art that could be utilized to clean surfaces that are not flat are the references that contain a hand-held wand and U.S. Pat. No. 6,267,308 B1 to Hall. Of course, the use of a hand-held wand to clean many miles of sidewalks and curbs is time consuming. The present invention improves upon the prior art through the use of a novel, curb-conforming, multi-nozzle spray nozzle apparatus.

### BRIEF SUMMARY OF THE INVENTION

The present invention solves the problems of the prior art by utilizing novel, curb-conforming, multi-nozzle spray nozzle apparatus and a mobile pressure washing unit to permit sidewalk cleaning without requiring human intervention. In addition, the novel, curb-conforming, multi-nozzle spray nozzle apparatus of the present invention is configured to address a variety of curb shapes, rather than the simple straight configurations of the prior art. The combination of these two items permit a significant reduction in the time and energy required to clean the curbs and sidewalks of a large neighborhood.

### BRIEF DESCRIPTION OF THE SEVERAL VIEWS OF THE DRAWINGS

FIG. 1 is a perspective of the novel, curb-conforming, multi-nozzle spray nozzle apparatus of the present invention utilized for high back curbs.

FIG. 2 is a perspective of the curb-conforming, multi-nozzle spray nozzle apparatus of the present invention utilized for type “D” curbs.

FIG. 3 is a perspective of the curb-conforming, multi-nozzle spray nozzle apparatus of the present invention utilized for miamis or valleys.

FIG. 4 is a top, plan view of the curb-conforming, multi-nozzle spray nozzle apparatus of the present invention containing an optional spray shield and guide driver.

FIG. 5 is a photograph of the front of one embodiment of the present invention.

FIG. 6 is a photograph of the partial side view of the mobile pressure washing unit and curb-conforming, multi-nozzle spray nozzle system of the present invention.

### DETAILED DESCRIPTION OF THE INVENTION

Throughout the claims and specification, the term “piping” means a hollow cylinder of metal, wood or other material, used for the conveyance of water, gas, steam, and the like. The water, gas or steam so conveyed may include additional additives useful in removing iron, rust, and the like, from the surface being sprayed.

Throughout the claims and specification, the term “curb-conforming” means straight piping and/or piping containing at least one angle of greater than about 5 degrees.

Throughout the claims and specification, the terms “at least one angle of greater than about 5 degrees” means any angle between 0 degrees and 360 degrees, including, but not limited to 45, 90, 249.5, and 270.

Throughout the claims and specification, the term “multiple,” when applied to nozzles or spray heads, means more than one, including, but not limited to, four, five, six, seven, eight and nine.

Throughout the claims and specification, the term “nozzle” or “spray head” means a spout from which water, gas, steam and the like is discharged and includes both stationary and rotary spray heads.

Throughout the claims and specification, the term “mobile platform” means a horizontal surface capable of moving.

The present invention is directed to novel, curb-conforming, multi-nozzle spray nozzle apparati and the mobile pressure washing units that utilize them. The following description of the drawings is not intended to limit, but merely serves as exemplary of the present invention.

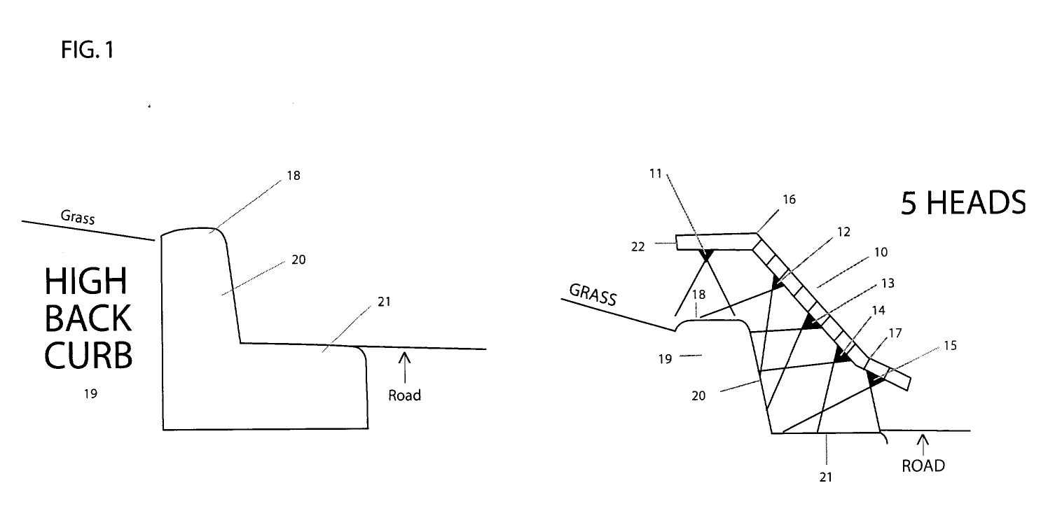

FIG. 1 shows one embodiment of the present invention as utilized for high back curbs. In this figure, the curb-conforming, multi-nozzle spray nozzle apparatus 10 contains five (5) spray heads; 11, 12, 13, 14, and 15. There is a 45 degree angle 16 in the curb-conforming piping 22 between spray heads 11 and 12. This angle 16 allows water from spray head 11 to be applied to the top 18 of the curb 19. There is a 249.5 degree angle 17 in the curb-conforming piping 22 between spray heads 14 and 15. This angle 17 allows water from spray head 15 to be applied to the bottom 21 of the curb 19. Spray heads 12, 13 and 14 apply water to the side 20 of the curb 19. These angles are for exemplary purposes only. Curbs of different height or width would require different angles at different positions. It would be within the ordinary skill of the art to adjust the curb-conforming, multi-nozzle spray nozzle apparatus appropriately.

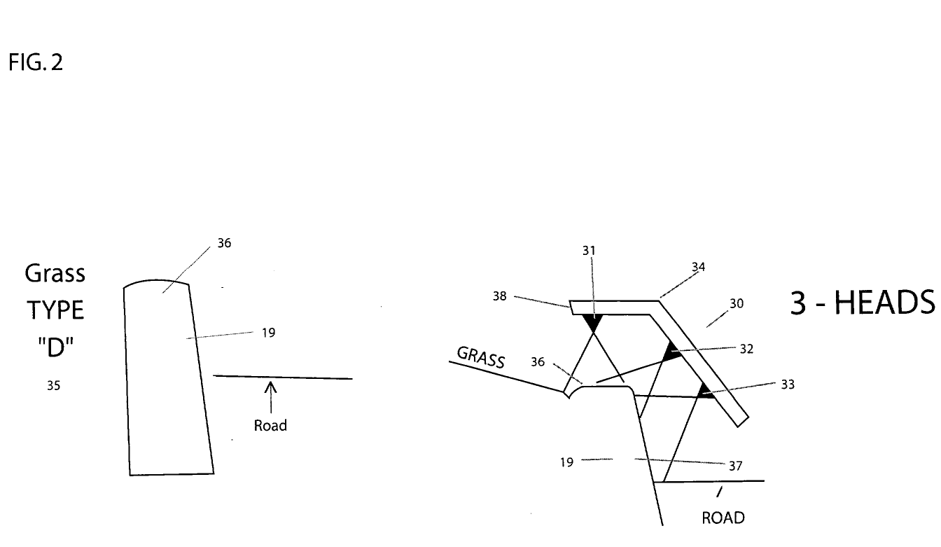

FIG. 2 shows a second embodiment of the present invention as utilized for Type D curbs. In this figure, the curb-conforming, multi-nozzle spray nozzle apparatus 30 contains three (3) spray heads; 31, 32 and 33. There is a 45 degree angle 34 in the curb-conforming piping 38 between spray heads 31 and 32. This angle 34 allows water from spray head 31 to be applied to the top 36 of the Type D curb 35. Spray heads 32 and 33 apply water to the side 37 of the Type D curb 35. Once again, these drawings are merely exemplary. It would be within the ordinary skill of the art to include additional spray heads for taller Type D curbs or to adjust the angle to suit specific curbs.

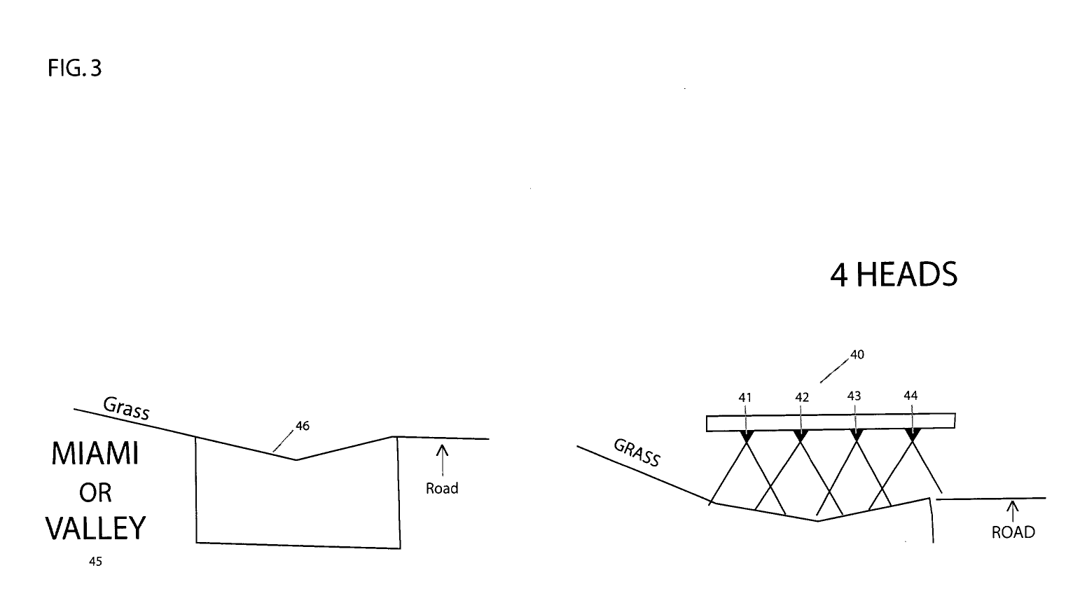

FIG. 3 provides a third embodiment of the present invention as utilized for miamis or valleys. In this figure, the curb-conforming, multi-nozzle spray nozzle apparatus 40 contains four (4) spray heads; 41, 42, 43 and 44. This embodiment of the curb-conforming, multi-nozzle spray nozzle system 40 does not contain any angles and contains four spray heads. Spray heads 41, 42, 43 and 44 apply water to the top 46 of the miami or valley 45. For emphasis, these drawings are merely exemplary. It would be within the ordinary skill of the art to include additional spray heads for wider miamis or valleys, or to add an angle to suit specific miamis or valleys.

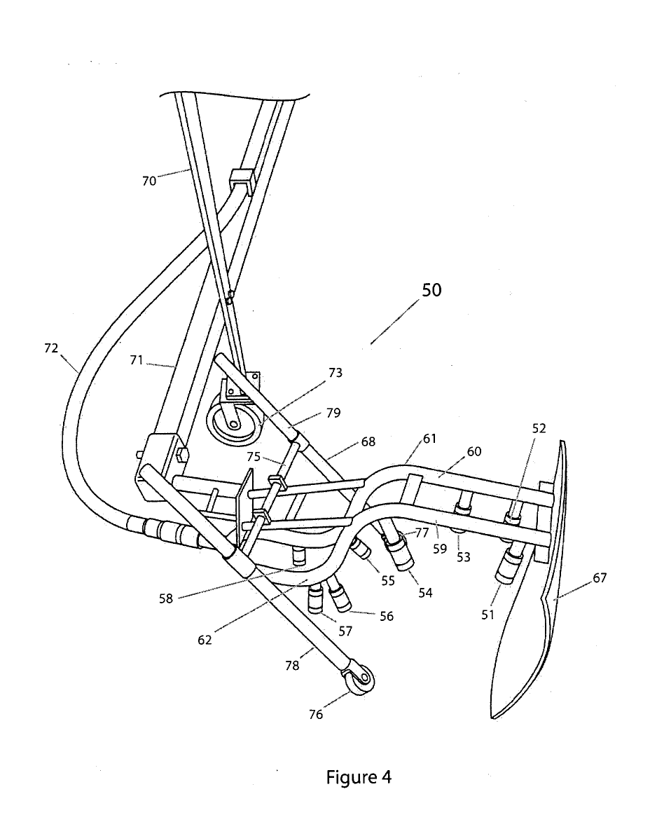

FIG. 4 provides a top, plan view of a fourth embodiment of the curb-conforming, multi-nozzle spray nozzle apparatus 50 of the present invention with an optional spray shield 67 and guide driver 68. In this figure, the curb-conforming, multi-nozzle spray nozzle apparatus 50 contains eight (8) spray heads (51, 52, 53, 54, 55, 56, 57 and 58) on two branches of curb-conforming piping (59 and 60). Each of the eight (8) spray heads (51, 52, 53, 54, 55, 56, 57 and 58) of this embodiment feature a shut-off valve (not shown) that allows each individual spray head to be shut off at the desire of the operator of the invention. Thus, when this embodiment of the present invention moves from one curb type to another curb type, the operator can simply close the spray heads that are not needed for the new curb type and proceed with cleaning.

The present invention may include from one to eight branches of curb-conforming piping depending upon the intended sidewalk to be cleaned. In the embodiment depicted in FIG. 4, there are two branches of curb-conforming piping (59 and 60). There is a 90 degree angle 61 in the curb-conforming piping (59 and 60) between spray heads 54 and 55. This angle 61 allows water from spray heads 51, 52 and 53 to be applied to the top 64 of the curb 63. There is a 270 degree angle 62 in the curb-conforming piping (59 and 60) between spray heads 56 and 57. This angle 62 allows water from spray heads 57 and 58 to be applied to the bottom 65 of the curb 63. Spray heads 54, 55 and 56 apply water to the side 66 of the curb 63. The number of branches of curb-conforming piping and the angles contained herein are for exemplary purposes only. Different curbs would require differing branch arrangements and angles. It would be within the ordinary skill of the art to adjust the curb-conforming, multi-nozzle spray nozzle apparatus appropriately.

FIG. 4 provides one embodiment of the attachment means of the present invention; this embodiment comprises an adjustable bracket swivel wheel 70 and spray boom 71. The adjustable bracket swivel wheel 70 provides support to the spray boom 71 during pressure spraying to ensure the proper height between the curb-conforming, multi-nozzle spray nozzle apparatus 50 and the surface being sprayed (not shown). The adjustable bracket swivel wheel 70 contains a tire 73 that can withstand the rigors of the proposed environment. Suitable materials include, but are not limited to, rubber, plastic and metal. It has been found that when the tire 73 is made from some forms of black rubber, the tire 73 leaves marks on the cleaned sidewalks. Therefore, it is preferable to choose a material that does not leave marks, such as a white or light-colored rubber, rubber/plastic mix, or dark-colored rubber that is treated with a sealant to prevent mark formation. The spray boom 71 connects the curb-conforming, multi-nozzle spray nozzle apparatus 50 of the present invention to the mobile platform (not shown). The spray boom 71 also needs to be able to withstand the rigors of the proposed environment. Suitable materials include, but are not limited to, stainless steel, iron and aluminum. As depicted in FIG. 4, the end of the multi-nozzle spray nozzle apparatus 50 is pinned and teed to the spray boom 71. However, other connecting mechanisms within the ordinary skill in the art would be utilized in the present invention, including, but not limited to t-handles, welding, bolts, nuts, screws and the like.

Not shown in FIG. 4 is the connection between the spray boom 71 and the mobile platform of the present invention. One embodiment of this connection comprises the addition of one or more receiver plates to the bumper of a mobile platform, which then receives the end of the spray boom 71. The spray boom is secured to the receiver plate by a cotter pin.

Another embodiment (not shown) of the connection between the spray boom 71 and the mobile platform of the present invention comprises the addition of two receiver plates to the front bumper of a 10-wheel water truck. One receiver plate is located on the driver side of the truck and the other is located on the passenger side. The spray boom 71 is mechanically connected to a hydraulic cylinder device, which is then connected to either receiver plate. The hydraulic cylinder device controls both the lateral and vertical position of the spray boom. The hydraulic cylinder device can be controlled from inside the 10-wheel water truck.

A further embodiment (not shown) includes the addition of actuators and electronic eyes to the hydraulic system described above. The electronic eyes are utilized by the operator of the water truck to view the positioning of the spray boom in relation to the curb from inside the water truck, or any other variant on the mobile platform. The actuators allow the operator to adjust the spray boom based on the results viewed from the electronic eyes.

The curb-conforming, multi-nozzle spray nozzle apparatus of FIG. 4 also includes the hose 72, the optional spray shield 67 and guide driver 68. The hose 72 connects the water source (not shown) to the curb-conforming, multi-nozzle spray nozzle apparatus 50 of the present invention. As depicted in FIG. 4, this connection mechanism is a quick disconnect mechanism, common in the hose industry. However, one of ordinary skill in the art would recognize that any non-leaking connection mechanism would be suitable in the present invention, including threading, cam locks or any other non-leaking connection means not currently well-known in the art.

The optional spray shield 67 in FIG. 4 prevents splashing from the spray heads from reaching areas not intended, such as the adjacent grass or other landscaping. The optional spray shield 67 can be manufactured from any material that withstands the rigors of the proposed environment. Suitable materials include, but are not limited to, rubber, plexiglass, plastic, or any combination thereof. The suitable materials include any material that exhibits flexibility but can withstand the pressure of concrete abrasion and high-pressure water.

The optional guide driver 68 in FIG. 4 can be used to assist in maintaining the proper distance between the spray heads and the curb. While the adjustable bracket swivel wheel 70 provides support to the curb-conforming, multi-nozzle spray nozzle apparatus 50, it is only used to maintain the elevation between the curb-conforming, multi-nozzle spray nozzle apparatus 50 and the road. The optional guide driver 68 rides down the crevice between the roadway and the curb, thereby assisting in maintaining the vertical distance between the curb-conforming, multi-nozzle spray nozzle apparatus 50 and the sidewalk. In FIG. 4, the optional guide driver 68 comprises two (2) stainless steel pipes, 78 and 79, an adjustable cross bar 75 and two (2) roller blade wheels, 76 and 77. The adjustable cross bar 75 allows movement of the curb-conforming, multi-nozzle spray nozzle apparatus without requiring movement of the spray boom 71. Therefore, an operator can adjust the curb-conforming, multi-nozzle spray nozzle apparatus of the present invention by adjusting the adjustable cross bar 75.

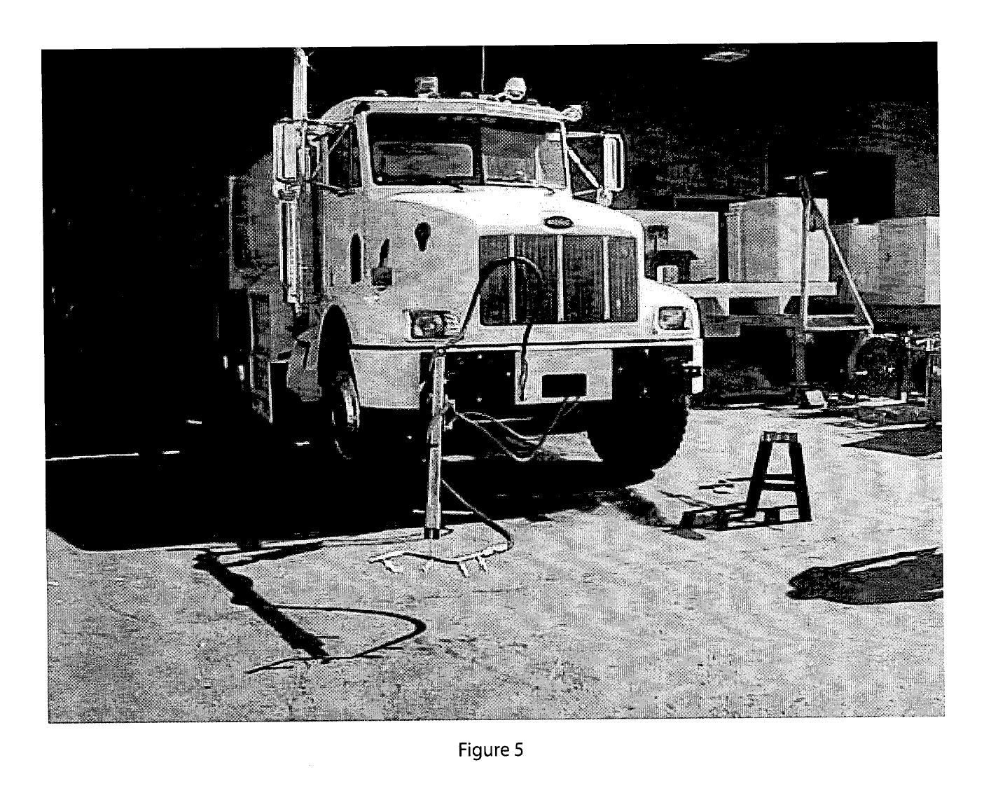

FIG. 5 is a photograph of the front of one embodiment of the mobile pressure washing unit and curb-conforming, multi-nozzle spray nozzle system of the present invention.

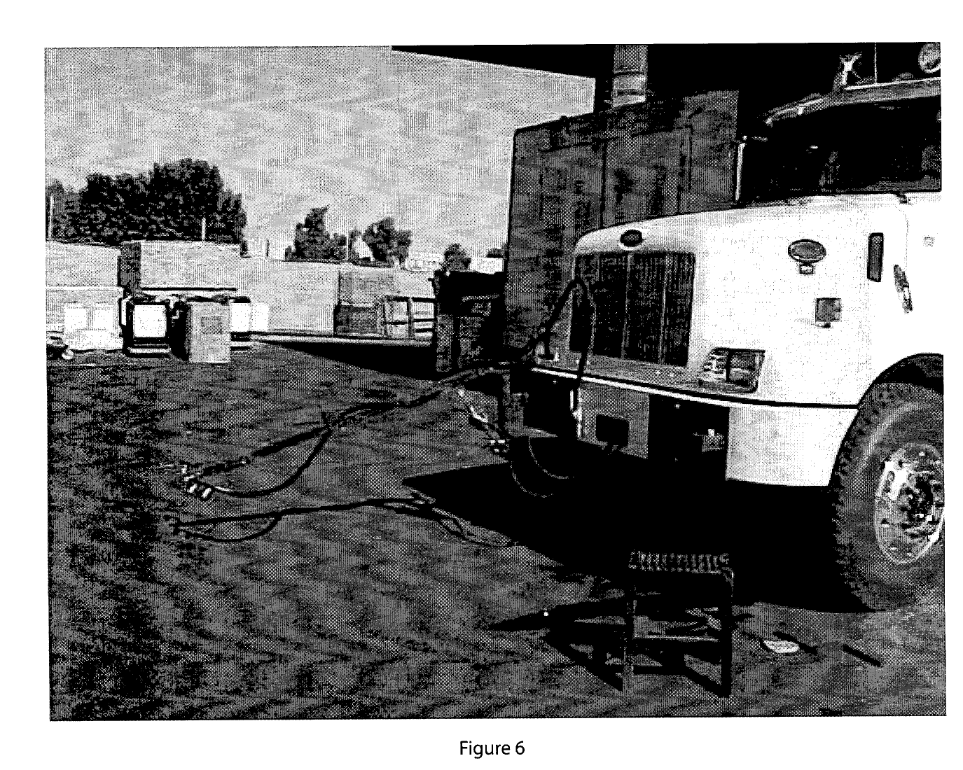

FIG. 6 is a photograph of the partial side view of one embodiment of the mobile pressure washing unit and curb-conforming, multi-nozzle spray nozzle system of the present invention.

The embodiments provided in the figures serve to exemplify, and not limit, the present invention. Clearly, two axle or even four axle vehicles could be used in place of the three axle vehicle depicted in FIGS. 4-6. All that is required of the mobile platform of the present invention is a motor to propel the invention and sufficient strength to hold a large water source.

We claim:

1. A curb-conforming, multi-nozzle spray nozzle apparatus comprising:
a. curb-conforming piping; and
b. multiple spray nozzles located along said curb-conforming piping.

2. The curb-conforming, multi-nozzle spray nozzle apparatus of claim 1 wherein said curb-conforming piping contains at least one angle of greater than about five (5) degrees.

3. The curb-conforming, multi-nozzle spray nozzle apparatus of claim 1 further comprising:
c. means to attach said curb-conforming, multi-nozzle spray nozzle apparatus to a mobile platform.

4. The curb-conforming, multi-nozzle spray nozzle apparatus of claim 3 wherein said attachment means comprise:
i) a spray boom comprising two ends,
wherein one end of said spray boom is attached to said mobile platform and the other end is attached to one end of said curb-conforming piping.

5. The curb-conforming, multi-nozzle spray nozzle apparatus of claim 4 wherein said attachment means further comprise:
ii) an adjustable bracket swivel wheel attached to said spray boom comprising:
a) a bracket comprising two ends; and
b) a swivel wheel,
wherein one end of said bracket is attached to said spray boom and
wherein the other end of said bracket is attached to said swivel wheel.

6. The curb-conforming, multi-nozzle spray nozzle apparatus of claim 1 further comprising:
d. a spray shield located at one end of said curb-conforming piping.

7. The curb-conforming, multi-nozzle spray nozzle apparatus of claim 4 further comprising:
d. a spray shield located at one end of said curb-conforming piping opposite to said end attached to said spray boom.

8. The curb-conforming, multi-nozzle spray nozzle apparatus of claim 3 further comprising:
e. a guide driver comprising a pole comprising two ends,
wherein one end of said pole is attached to said attachment means,
wherein the other end of said pole comprises a wheel.

9. A mobile pressure washing unit comprising:
a. a mobile platform comprising;
i. a water source;
ii. a water pump; and
iii. a curb-conforming, multi-nozzle spray nozzle apparatus comprising
a). curb-conforming piping; and
b). multiple spray nozzles located along said curb-conforming piping.

10. The mobile pressure washing unit of claim 9 wherein said mobile platform is self-propelled.

11. The mobile pressure washing unit of claim 9 wherein said mobile platform is a truck.

12. The mobile pressure washing unit of claim 9 wherein said water source comprises at least two thousand six hundred (2,600) gallons of water.

13. The mobile pressure washing unit of claim 9 wherein said curb-conforming piping contains at least one angle of greater than about five (5) degrees.

14. The curb-conforming, multi-nozzle spray nozzle apparatus of claim 9 further comprising:
c. means to attach said curb-conforming, multi-nozzle spray nozzle apparatus to a mobile platform.

15. The curb-conforming, multi-nozzle spray nozzle apparatus of claim 14 wherein said attachment means comprise:
i) a spray boom comprising two ends,
wherein one end of said spray boom is attached to said mobile platform and the other end is attached to one end of said curb-conforming piping.

16. The curb-conforming, multi-nozzle spray nozzle apparatus of claim 15 wherein said attachment means further comprise:
ii) an adjustable bracket swivel wheel attached to said spray boom comprising:
a) a bracket comprising two ends; and
b) a swivel wheel,
wherein one end of said bracket is attached to said spray boom and
wherein the other end of said bracket is attached to said swivel wheel.

17. The curb-conforming, multi-nozzle spray nozzle apparatus of claim 9 further comprising:
d. a spray shield located at one end of said curb-conforming piping.

18. The curb-conforming, multi-nozzle spray nozzle apparatus of claim 15 further comprising:
d. a spray shield located at one end of said curb-conforming piping opposite to said end attached to said spray boom.

19. The curb-conforming, multi-nozzle spray nozzle apparatus of claim 14 further comprising:
e. a guide driver comprising a pole comprising two ends,
wherein one end of said pole is attached to said attachment means,
wherein the other end of said pole comprises a wheel.
